(19) United States
(12) Patent Application Publication
(10) Pub. No.: US 2012/0294604 A1
(43) Pub. Date: Nov. 22, 2012

(54) OPTICAL PROTECTION AND SWITCH ENABLED OPTICAL REPEATING

(75) Inventor: James W. Roberts, Allen, TX (US)

(73) Assignee: XTERA COMMUNICATIONS, INC., Allen, TX (US)

(21) Appl. No.: 13/467,458

(22) Filed: May 9, 2012

Related U.S. Application Data
(60) Provisional application No. 61/486,699, filed on May 16, 2011.

(51) Int. Cl. H04B 10/16

(52) U.S. Cl. 398/5

(57) ABSTRACT

An optical transmission system or its constituent repeater disposed optically between two terminals. The system includes at least two parallel optical paths between a first node and the repeater (one optical path being used as a backup for another), and another at least two parallel optical paths between a second node and the repeater (again, one optical path being used as a backup for another). The first nodes may, but need not, be terminals, but could also be repeaters, or other optical elements. For a signal traveling from the first terminal to the second terminal, the optical switching mechanism detects which of the at least two parallel optical paths an optical signal is being received from the first node, and channels the optical signal to at least one of the parallel optical paths leading from the repeater to the second node.

### CROSS-REFERENCE TO RELATED APPLICATIONS

This application is a non-provisional of, and claims priority to and the benefit of, U.S. Patent Application Ser. No. 61/486,699 filed on May 16, 2011 and entitled “OPTICAL PROTECTION AND SWITCH ENABLED OPTICAL REPEATING,” which application is hereby expressly incorporated herein by this reference in its entirety.

### BACKGROUND OF THE INVENTION

Fiber-optic communication networks serve a key demand of the information age by providing high-speed data between network nodes. Fiber-optic communication networks include an aggregation of interconnected fiber-optic links. Simply stated, a fiber-optic link involves an optical signal source that emits information in the form of light into an optical fiber. Due to principles of internal reflection, the optical signal propagates through the optical fiber until it is eventually received into an optical signal receiver. If the fiber-optic link is bi-directional, information may be optically communicated in reverse typically using a separate optical fiber.

Fiber-optic links are used in a wide variety of applications, each requiring different lengths of fiber-optic links. For instance, relatively short fiber-optic links may be used to communicate information between a computer and its proximate peripherals, or between local video source (such as a DVD or DVR) and a television. On the opposite extreme, however, fiber-optic links may extend hundreds or even thousands of kilometers when the information is to be communicated between two network nodes.

Long-haul and ultra-long-haul optics refers to the transmission of light signals over long fiber-optic links on the order of hundreds or thousands of kilometers between terminals. Typically, long-haul optics involves the transmission of optical signals on separate channels over a single optical fiber, each channel corresponding to a distinct wavelength of light using principles of Wavelength Division Multiplexing (WDM) or Dense WDM (DWDM). Long-haul and ultra-long-haul optics often use optical repeaters between terminals to provide optical amplification to an optical signal that attenuates as it passes through the optical fiber.

The effective transmission of optical signals over such long distances using WDM or DWDM presents enormous technical challenges, especially at high bit rates in the gigabits per second per channel range. Significant time and resources may be required for any improvement in the art of high speed long-haul and ultra-long-haul optical communication. Each improvement can represent a significant advance since such improvements often lead to the more widespread and convenient availability of communications throughout the globe. Thus, such advances may potentially accelerate humankind's ability to collaborate, learn, do business, and the like, with geographical location becoming less and less relevant.

### BRIEF SUMMARY OF THE INVENTION

Embodiments described herein relate to an optical transmission system that includes a repeater disposed optically between two terminals. The system includes at least two parallel optical paths between a first node and the repeater (one optical path being used as a backup for another), and another at least two parallel optical paths between a second node and the repeater (again, one optical path being used as a backup for another). The first node and second nodes may each be a terminal, repeater, or other optical elements. For a signal traveling from the first terminal to the second terminal, the optical switching mechanism receives the optical signal from a backup path, even if the primary path is defective, and channels the optical signal to at least one of the parallel optical paths leading from the repeater to the second node.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an optical communication system in which the principles described herein may be employed;

FIG. 2 illustrates an optical transmission system that includes an optical repeater intervening between two optical nodes in an optical communication system;

FIG. 3A illustrates the optical transmission system of claim 1, with both optical nodes being terminals;

FIG. 3B illustrates the optical transmission system of claim 1, with only the left optical node being a terminal;

FIG. 3C illustrates the optical transmission system of claim 1, with only the right optical node being a terminal;

FIG. 3D illustrates the optical transmission system of claim 1, with neither of the optical nodes being terminals; and

FIG. 4 schematically illustrates the intervening repeater of FIG. 2 in further detail.

### DETAILED DESCRIPTION OF THE PREFERRED EMBODIMENTS

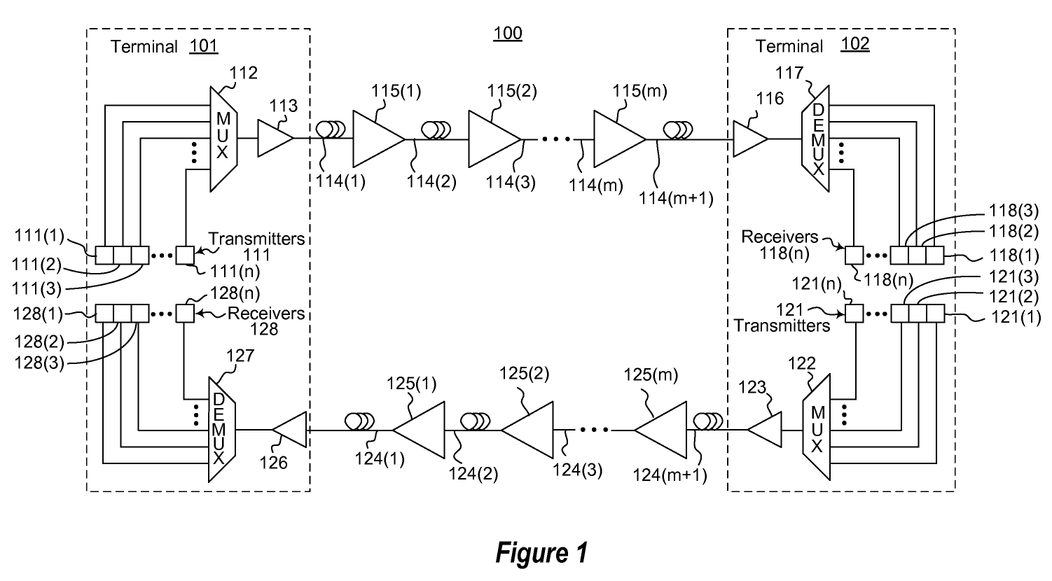

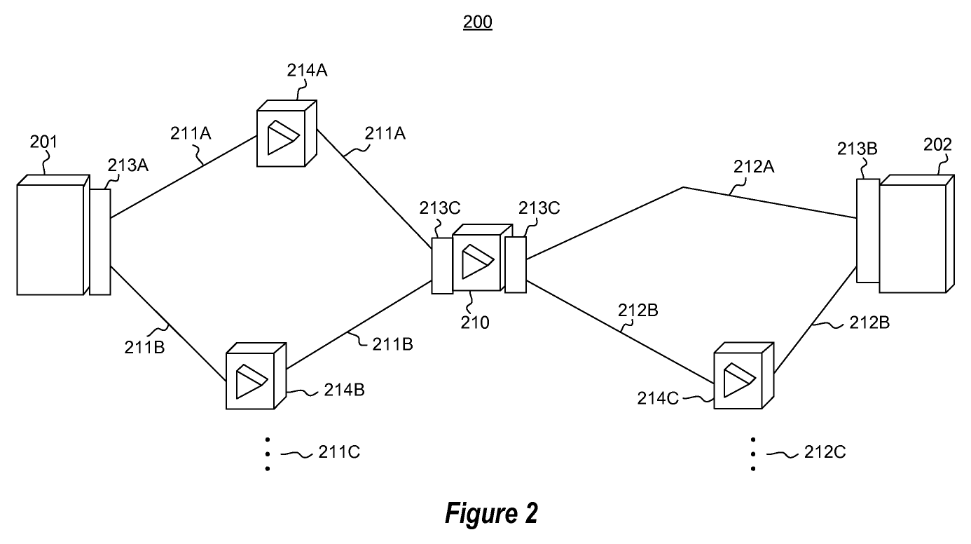

In accordance with embodiments described herein, a repeater may be used to perform optical protection and switching. An example optical communications system will first be described with respect to FIG. 1. Then, further details of the optical protection and switching will be described with respect to FIGS. 2 through 4.

FIG. 1 schematically illustrates an example optical communications system 100 in which the principles described herein may be employed. In the optical communications system 100, information is communicated between terminals 101 and 102 via the use of optical signals. For purposes of convention used within this application, optical signals travelling from the terminal 101 to terminal 102 will be referred to as being “eastern”, whereas optical signals traveling from the terminal 102 to the terminal 101 will be referred to as being “western”. The terms “eastern” and “western” are simply terms of art used to allow for easy distinction between the two optical signals traveling in opposite directions. The use of the terms “eastern” and “western” does not imply any actual geographical relation of components in FIG. 1, nor to any actual physical direction of optical signals. For instance, terminal 101 may be geographical located eastward of the terminal 102, even though the convention used herein has “eastern” optical signals traveling from the terminal 101 to the terminal 102.

In one embodiment, the optical signals are Wavelength Division Multiplexed (WDM) and potentially Dense Wavelength Division Multiplexed (DWDM). In WDM or DWDM, information is communicated over each of multiple distinct optical channels called hereinafter “optical wavelength channels”. Each optical wavelength channel is allocated a particular frequency for optical communication. Accordingly, in order to communicate using WDM or DWDM optical signals, the terminal 101 may have “n” optical transmitters 111 (including optical transmitters 111(1) through 111(n), where n is a positive integer), each optical transmitter for transmitting over a corresponding eastern optical wavelength channel. Likewise, the terminal 102 may have “n” optical transmitters 121 including optical transmitters 121(1) through 121(n), each also for transmitting over a corresponding western optical wavelength channel. The principles described herein are not limited, however, to communications in which the number of eastern optical wavelength channels is the same as the number of western optical wavelength channels. Furthermore, the principles described herein are not limited to the precise structure of the each of the optical transmitters. However, lasers are an appropriate optical transmitter for transmitting at a particular frequency. That said, the optical transmitters may each even be multiple laser transmitters, and may be tunable within a frequency range.

As for the eastern channel for optical transmission in the eastern direction, the terminal 101 multiplexes each of the eastern optical wavelength signals from the optical transmitters 111 into a single eastern optical signal using optical multiplexer 112, which may then be optically amplified by an optional eastern optical amplifier 113 prior to being transmitted onto a first fiber link 114(1).

As illustrated, there are a total of “m” repeaters 115 (labeled 115(1) through 115(m)) and “m+1” optical fiber links 114 (labeled 114(1) through 114(m+1) between the terminals 101 and 102 in the eastern channel. In the illustrated case, there are also a total of “m” repeaters 125 (labeled 125(1) through 125(m)) and “m+1” optical fiber links 124 (labeled 124(1) through 124(m+1)) between the terminals 101 and 102 in the western channels. However, there is no requirement for the number of repeaters in each of the eastern and western channels to be equal. In an unrepeatered optical communication system, “m” would be zero such that there is but a single fiber link 114(1) and no repeaters between the terminals 101 and 102. In a repeatered optical communication system, “m” would be one or greater. Each of the repeaters, if present, may consume electrical power to thereby amplify the optical signals.

The eastern optical signal from the final optical fiber link 114(m+1) is optionally amplified at the terminal 102 by the optional optical amplifier 116. The eastern optical signal is then demultiplexed into the various wavelength optical wavelength channels using optical demultiplexer 117. The various optical wavelength channels may then be received and processed by corresponding optical receivers 118 including receivers 118(1) through 118(n). Alternatively, if there were a branching unit (not shown) present in the eastern channel, there may be fewer or greater than n optical signals demultiplexed by the demultiplexer 117.

As for the western channel for optical transmission in the western direction, the terminal 102 multiplexes each of the western optical wavelength signals from the optical transmitters 121 (including optical transmitters 121(1) through 121(n)) into a single western optical signal using the optical multiplexer 122. The multiplexed optical signal may then be optically amplified by an optional western optical amplifier 123 prior to being transmitted onto a first fiber link 124(m+1). If the western optical channel is symmetric with the eastern optical channel, there are once again “m” repeaters 125 (labeled 125(1) through 125(m)), and “m+1” optical fiber links 124 (labeled 124(1) through 124(m+1)). Recall that in an unrepeatered environment, “m” may be zero such that there is only one optical fiber link 124(1) and no repeaters 125 in the western channel.

The western optical signal from the final optical fiber link 124(1) is then optionally amplified at the terminal 101 by the optional optical amplifier 126. The western optical signal is then demultiplexed using optical demultiplexer 127, whereupon the individual wavelength division optical channels are received and processed by the receivers 128 (including receivers 128(1) through 128(n)). Alternatively, if there were a branching unit (not shown) present in the western channel, there may be fewer or greater than n optical signals demultiplexed by the demultiplexer 127.

Terminals 101 and/or 102 do not require all the elements shown in optical communication system 100. For example, optical amplifiers 113, 116, 123, and/or 126 might not be used in some configurations. Furthermore, if present, each of the corresponding optical amplifiers 113, 116, 123 and/or 126 may be a combination of multiple optical amplifiers if desired.

Often, the optical path length between repeaters is approximately the same. The distance between repeaters will depend on the total terminal-to-terminal optical path distance, the data rate, the quality of the optical fiber, the loss-characteristics of the fiber, the number of repeaters (if any), the amount of electrical power deliverable to each repeater (if there are repeaters), and so forth. However, a typical optical path length between repeaters (or from terminal to terminal in an unrepeatered system) for high-quality single mode fiber might be about 50 kilometers, and in practice may range from 30 kilometers or less to 90 kilometers or more. That said, the principles described herein are not limited to any particular optical path distances between repeaters, nor are they limited to repeater systems in which the optical path distances are the same from one repeatered segment to the next.

The optical communications system 100 is represented in simplified form for purpose of illustration and example only. The principles described herein may extend to much more complex optical communications systems. The principles described herein may apply to optical communications in which there are multiple fiber pairs, each for communicating multiplexed WDM optical signals. Furthermore, the principles described herein also apply to optical communications in which there are one or more branching nodes that split one or more fiber pairs and/or optical wavelength channels in one direction, and one or more fiber pairs and/or optical wavelength channels in another direction.

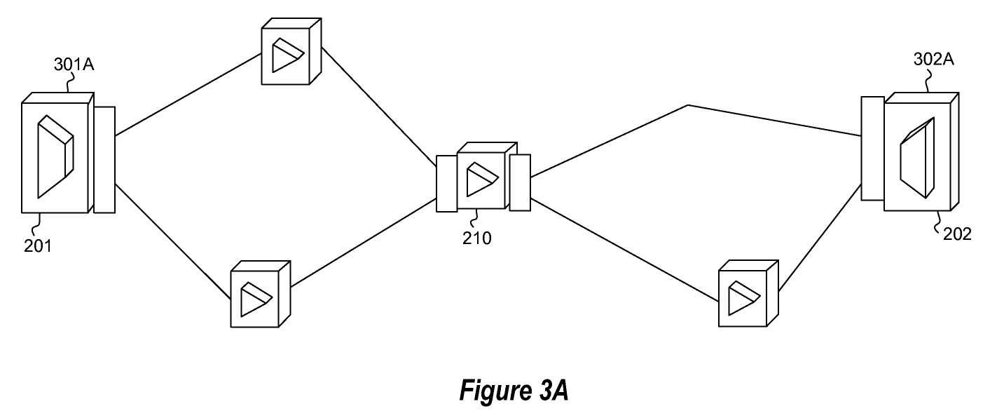

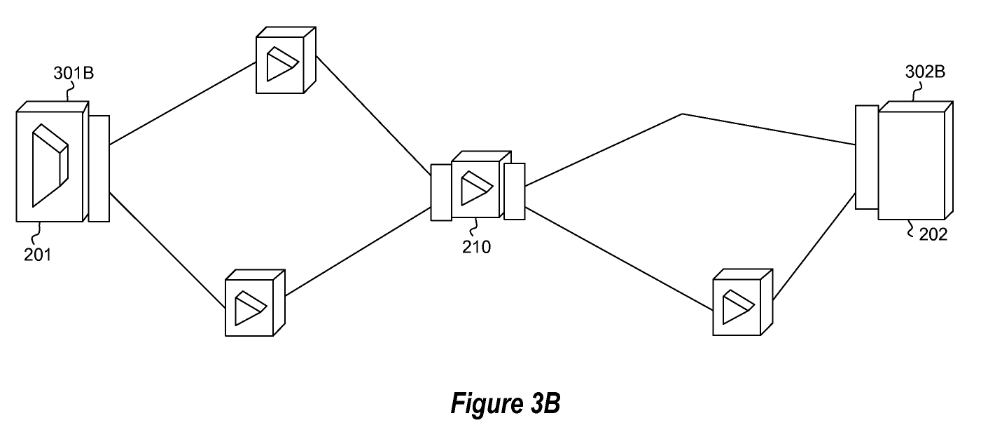

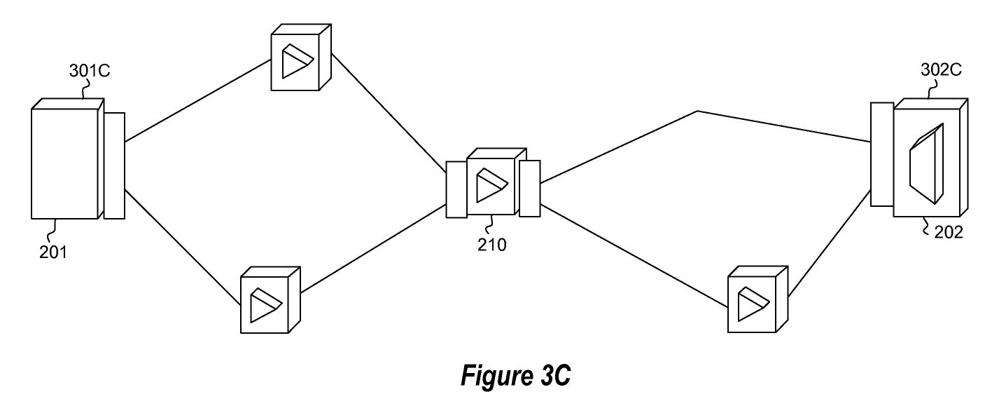

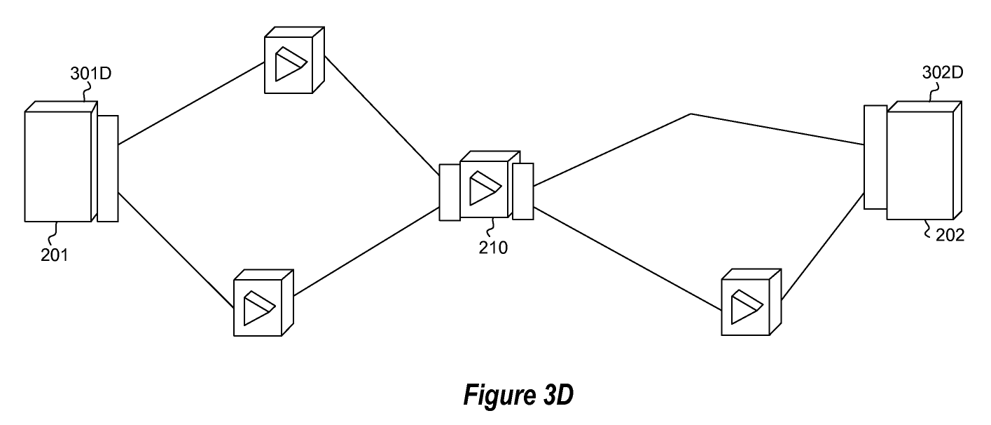

FIG. 2 illustrates at least a portion of an optical transmission system 200 that includes a repeater 210 optically disposed between the first node 201 and second node 202. In this description and in the claims, the terms “first”, “second” and so forth are used simply to distinguish one item from another unless otherwise specified. These terms are not intended to imply anything regarding ordering, priority, or the like. There are two illustrated optical paths 211A and 211B optically coupling the first optical node 201 and the repeater 210. The ellipses 211C represent that there may be more optical paths between the first optical node 201 and the repeater 210. There are also two illustrated optical paths 212A and 212B optically coupled the second optical node 202 and the repeater 210. Likewise, the ellipses 212C represent that there may be more optical paths between the second optical node 202 and the repeater 210. As will be described with respect to the various configurations of FIGS. 3A through 3D, the optical nodes 201 may be terminals, repeaters, or another type of optical element such as a branching unit or optical add/drop multiplexer (OADM).

The transmission and switching for optical signals traveling from the first node 201 to the second node 202 through repeater 210 will now be described. The first optical node 201 includes a switching mechanism 213A that allows for the transmission of optical signals over at least one of the primary optical path 211A or the backup optical path 211B, or one of the other optical paths 211C (if present). In one embodiment, the switching mechanism transmits over all of the primary optical path 211A and the backup optical path 211B. In that case, the switching mechanism 213A acts as a coupler. In another embodiment, the switching mechanism 213A transmits over the primary optical path 211A if the primary optical path 211A is not defective to the point where such transmissions are impractical. In that embodiment, if the primary optical path 211A is defective, then the switching mechanism 213A transmits the optical signals over the backup optical path 211B or one of the other optical paths 211C (if present) between the first optical node 201 and the terminal 210.

The repeater 210 also includes an optical switching mechanism 213C that is configured to detect which of the optical paths 211A, 211B or 211C (hereinafter, also collectively referred to as “optical paths 211”) over which the optical signal is being received from the first optical node 201. Furthermore, the optical switching mechanism 213C channels the optical signal to at least one of the primary optical path 212A or the backup optical path 212B, or one of the other optical paths 212C (if present). In one embodiment, the switching mechanism transmits over all of the primary optical path 212A and the backup optical path 212B. In that case, the switching mechanism 213C acts as a coupler on the transmit side. In another embodiment, the switching mechanism 213C transmits over the primary optical path 212A if the primary optical path is not defective so as to render the primary optical path 212A impractical for use. In that embodiment, if the primary optical path 212A is defective the optical switching mechanism 213C transmits the optical signal over the backup optical path 212B, or one of the other optical paths 212C, if present.

The second optical node 202 also includes a switching mechanism 213B that is configured to detect which of the optical paths 212A, 212B or 212C (hereinafter, also collectively referred to as “optical paths 212”) over which the optical signal is being received from the repeater 210. The optical signal is then further provided to the second optical node 202.

The transmission and switching for optical signals traveling from the second node 202 to the first node 201 through repeater 210 will now be described. The switching mechanism 213B of the second optical node 202 allows for the transmission of optical signals over at least one of the primary optical path 212A or the backup optical path 212B, or one of the other optical paths 212C (if present). In one embodiment, the switching mechanism transmits over all of the primary optical path 212A and the backup optical path 212B. In that case, the switching mechanism 213B acts as a coupler. In another embodiment, the switching mechanism 213B transmits over the primary optical path 212A if the primary optical path 212A is not defective to the point where such transmissions are impractical. In that embodiment, if the primary optical path 212A is defective, then the switching mechanism 213B transmits the optical signals over the backup optical path 212B or one of the other optical paths 212C (if present) between the second optical node 202 and the terminal 210.

The optical switching mechanism 213C of the repeater 210 is configured to detect which of the optical paths 212A, 212B or 212C over which the optical signal is being received from the second optical node 202. Furthermore, the optical switching mechanism 213C channels the optical signal to at least one of the primary optical path 211A or the backup optical path 211B, or one of the other optical paths 211C (if present). In one embodiment, the switching mechanism transmits over all of the primary optical path 211A and the backup optical path 211B. In that case, the switching mechanism 213C acts as a coupler on the transmit side. In another embodiment, the switching mechanism 213C transmits over the primary optical path 211A if the primary optical path is not defective so as to render the primary optical path 211A impractical for use. In that embodiment, if the primary optical path 212A is defective, the optical switching mechanism 213C transmits the optical signal over the backup optical path 211B, or one of the other optical paths 211C, if present.

The switching mechanism 213A of the first optical node 201 detects which of the optical paths 211A, 211B or 211C over which the optical signal is being received from the repeater 210. The optical signal is then further provided to the first optical node 201.

Each of the optical paths 211A, 211B, 211C, 212A, 212B and 212C may have zero one or more repeaters optically positioned between their respective optical nodes 201 or 202 and the repeater 210. As an example only, a repeater 214A is shown optically positioned within the primary optical path 211A, a repeater 214B is shown optically positioned within the backup optical path 211B, and the repeater 214C is shown optically positioned within backup optical path 212B. No repeater is shown disposed within the primary optical path 212A. Similar repeater configurations will also be illustrated in FIGS. 3A through 3D, although the broader principles are not limited to the number of repeaters in the optical paths 211A, 211B, 211C, 212A, 212B or 212C.

The optical paths 211A, 211B, 211C, 212A, 212B and 212C may be quite lengthy. For instance, the average optical length (i.e., the distance the light travels) of such optical paths may be 50 kilometers, or even more—perhaps even several hundred kilometers or more.

As previously mentioned, the first optical node 201 may be a terminal, a repeater, an optical add/drop multiplexer (OADM), a branching unit or another optical node. Likewise, the second optical node 202 may be a terminal, a repeater, an optical add/drop multiplexer (OADM), a branching unit or another optical node.

FIG. 3A illustrates the optical transmission system of FIG. 2, except now with each of the optical nodes 201 and 202 being a terminal. Specifically, optical node 201 is a terminal 301A, and the optical node 202 is a terminal 301A. In FIGS. 3A through 3D, for clarity, the components of the optical transmission system are not all labeled as they are in FIG. 2. Instead, just the optical repeater 210, and the optical nodes 201 and 202 are labeled. Comparing FIGS. 1 and 3A, the terminal 301A may be, for example, the terminal 101, and the terminal 302A may be, for example, the terminal 102. The repeater 210 may be any one of repeaters 115(1) through 115(m) if operating on eastern optical signals, or any one of repeaters 125(1) through 125(m) if operating on western optical signals. If bi-directional, the repeater 210 may be any one of repeaters 115(1) through 115(m) in combination with the one of repeaters 125(1) through 115(m) that happens to be proximate. Of course, the optical communication system 100 does not show parallel optical communication paths in each direction, though they would be present if applied to FIGS. 2 and 3A through 3D.

FIG. 3B illustrates the optical transmission system of FIG. 2, except now with only one of the optical nodes 201 is a terminal. Specifically, optical node 201 is a terminal 301B, and the optical node 202 is another type of optical node 302B such as a repeater, branching unit, OADM or other. Comparing FIGS. 1 and 3B, the terminal 301B may be, for example, the terminal 101, and the other node 302B (if a repeater) may be, for example, any one of repeaters 115(2) through 115(m) if operating only in the eastern direction, or any one of repeaters 125(2) through 125(m) if operating only in the western direction, or a combination thereof if bidirectional. The repeater 210 of FIG. 3B may be any repeater (e.g., repeater 115(1) and/or repeater 125(1)) between the terminal 101 and the other node 302B.

FIG. 3C illustrates the optical transmission system of FIG. 2, except now with only the other optical node 202 being a terminal. Specifically, optical node 202 is a terminal 302C, and the optical node 201 is another type of optical node 301C such as a repeater, branching unit, OADM or other. Comparing FIGS. 1 and 3C, the terminal 302C may be, for example, the terminal 102, and the other node 301C (if a repeater) may be, for example, any one of repeaters 115(1) through 115(m−1) if operating only in the eastern direction, or any one of repeaters 125(1) through 125(m−1) if operating only in the western direction, or a combination thereof if bidirectional. The repeater 210 of FIG. 3C may be any repeater (e.g., repeater 115(m) and/or repeater 125(m)) between the terminal 102 and the other node 301C.

FIG. 3D illustrates the optical transmission system of FIG. 2, except now none of the optical nodes 201 or 202 are a terminal. Specifically, optical node 201 is another type of optical node 301D (such as a repeater, branching unit, or other), and the other optical node is also another type of optical node 302D (such as a repeater, branching unit, or other). Comparing FIGS. 1 and 3D, the optical node 301D may be, for example, any one of repeaters 115(1) through 115(m−1) if operating only in the eastern direction, or any one of repeaters 125(1) through 125(m−1) if operating only in the western direction, or a combination thereof if bidirectional. The optical node 302D may be, for example, any one of repeaters 115(2) through 115(m) if operating only in the eastern direction, or any one of repeaters 125(2) through 125(m) if operating only in the western direction, or a combination thereof if bidirectional, so long as the node 302D is between the node 301D and the terminal 102 in the optical path.

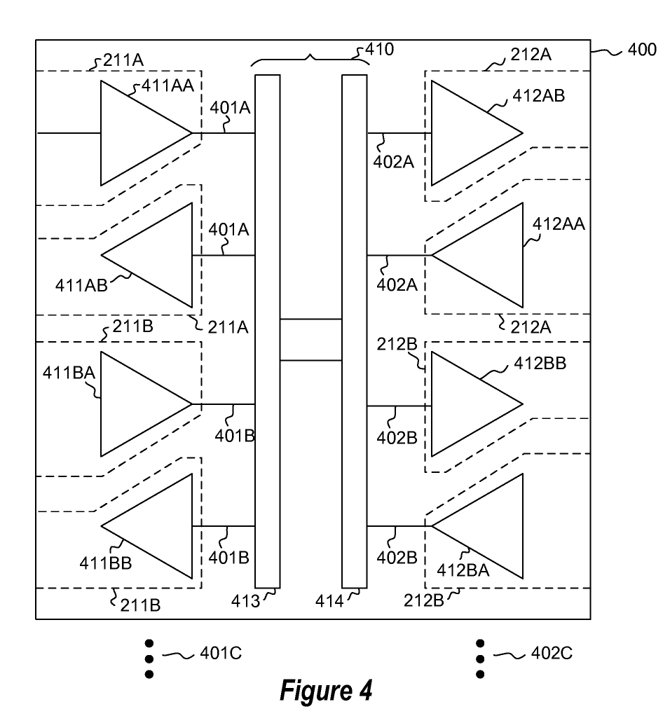

FIG. 4 abstractly illustrates an optical repeater 400 that represents an example of the optical repeater 210 and optical switching mechanism 210 of FIG. 2. The optical repeater 400 includes 1) a primary connection 401A for optical coupling to the primary optical path 211A that extends to the first optical node 201 (shown in FIG. 2), and 2) a backup connection 401B for optical coupling to the backup optical path 211B that extends to the first optical node 201. The ellipses 401C represents that there may be other similar connections and components if there are further optical paths as represented by the ellipses 211C of FIG. 2.

The optical repeater 400 also includes 1) a primary connection 402A for optical coupling to the primary optical path 212A that extends to the second optical node 202 (shown in FIG. 2), and 2) a backup connection 402B for optical coupling to the backup optical path 212B that extends to the second optical node 202. The ellipses 402C represents that there may be other similar connections and components if there are further optical paths as represented by the ellipses 212C of FIG. 2.

The optical repeater 400 includes an optical switching mechanism 410, which is one embodiment of the optical switching mechanism 210 of FIG. 2. The optical switching mechanism 410 is configured to receive optical signals over the primary optical path 211A, or the backup optical path 211B or 211C if the primary optical path 211A is defective, and configured to provide the received optical signals to at least one of the primary optical path 212A or the backup optical path 212B or 212C as previously described. The switching mechanism 410 may automatically detect when the primary optical path 211A or 212A are defective, and act accordingly as specified above.

In the bi-directional case, which is illustrated in FIG. 4, the optical switching mechanism 410 is further configured to receive optical signals over the primary optical path 212A, or the second backup optical path 212B or 212C if the primary optical path 212A is defective, and configured to provide the received optical signals to at least one of the primary optical path 211A or the backup optical path 211B or 211C as previously described.

In FIG. 4, a portion of the primary optical path 211A is illustrated as being included within the repeater 400 and includes a line amplifier 411AA for amplifying optical signals received from the first optical node 201 over the optical path 211A, and also includes a booster amplifier 411AB for amplifying an optical signal being transmitted to the first optical node 201 over the optical path 211A.

A portion of the backup optical path 211B is illustrated as being included within the repeater 400 and includes a line amplifier 411 BA for amplifying optical signals received from the first optical node 201 over the optical path 211B, and also includes a booster amplifier 411BB for amplifying an optical signal being transmitted to the first optical node 201 over the optical path 211B.

A portion of the primary optical path 212A is illustrated as being included within the repeater 400 and includes a line amplifier 412AA for amplifying optical signals received from the second optical node 202 over the optical path 212A, and also includes a booster amplifier 412AB for amplifying an optical signal being transmitted to the second optical node 202 over the optical path 212A.

A portion of the backup optical path 212B is illustrated as being included within the repeater 400 and includes a line amplifier 412BA for amplifying optical signals received from the second optical node 202 over the optical path 212B, and also includes a booster amplifier 412BB for amplifying an optical signal being transmitted to the second optical node 202 over the optical path 212B.

The optical switching mechanism 410 includes a first optical protection and switching circuit module 413 and a second optical protection and switching circuit 414. The first optical protection and switching circuit module 413 is configured to receive the optical signals over the primary optical path 211A, or the backup optical path 211B if the primary optical path 211B is defective. In other words, the module 413 switches to the good signal. The second optical protection and switching circuit module 414 is configured to transmit the optical signal received by the first optical protection and switching circuit module 413 to the primary optical path 212A and to the backup optical path 212B. In the other direction, the second optical protection and switching circuit module 414 is further configured to receive the optical signals over the primary optical path 212A, or the backup optical path 212B if the primary optical path 212A is defective. The first optical protection and switching circuit module 413 is further configured to transmit the optical signals received by the second optical protection and switching circuit module 414 to the primary optical path 211A and to the backup optical path 211B.

The principles described herein provide a great level of redundancy in case of optical path failure, and compensates for many types of failures in an optical path such as a fiber cut or defect, failures in line or booster amplifiers, and failures in repeaters that are within the optical path. Furthermore, several optical paths may fail without the optical transmission system failing. For instance, referring to FIG. 2, suppose that there are four optical paths 211A, 211B, 212A and 212B. Any one of these optical paths may fail while still providing optical communication between optical nodes 201 and 202. Furthermore, two of the optical paths may fail in some cases while still providing optical communication between optical nodes 201 and 202, so long as there is one optical path available between optical node 201 and repeater 210, and so long as there is one optical path available between optical node 202 and repeater 210. Thus, a highly resilient switching system is described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical repeater comprising:
a first primary connection for optical coupling to a first primary optical path that extends to a first node in an optical transmission system, wherein the first node is either a first terminal in the optical transmission system, or a node optically between the first terminal and the optical repeater, the first primary optical path being used for communication of an optical signal if the first primary optical path is not defective;
a first backup connection for optical coupling to a first backup optical path that extends to the first node;
a second primary connection for optical coupling to a second primary optical path that extends to a second node in an optical transmission system, wherein the second node is either a second terminal in the optical transmission system, or a node optically between the second terminal and the optical repeater, the second primary optical path being used for communication of an optical signal if the second primary optical path is not defective;
a second backup connection for optical coupling to a second backup optical path that extends to the second node; and
an optical switching mechanism configured to receive optical signals over the first primary optical path, or the first backup optical path if the first primary optical path is defective, and configured to provide the received optical signals to at least one of the second primary optical path or the second backup optical path.

2. The optical repeater in accordance with claim 1, wherein the optical switching mechanism is further configured to automatically detect when the first primary optical path is defective.

3. The optical repeater in accordance with claim 1, wherein the optical switching mechanism is configured to provide the received optical signals to both of the second primary optical path and the second backup optical path simultaneously.

4. The optical repeater in accordance with claim 1, wherein the optical switching mechanism is configured to provide the received optical signals to the second primary optical path if the second primary optical path is not defective, and to the second backup optical path if the second primary optical path is defective.

5. The optical repeater in accordance with claim 1, further comprising:
a portion of the first primary optical path that includes a first line amplifier;
a portion of the first backup optical path that includes a second line amplifier;
a portion of the second primary optical path that includes a first booster amplifier; and
a portion of the second backup optical path that includes a second booster amplifier.

6. The optical repeater in accordance with claim 1, wherein the received optical signals are first received optical signals, wherein the optical switching mechanism is further configured to receive second optical signals over the second primary optical path, or the second backup optical path if the second primary optical path is defective, and configured to provide the second received optical signals to at least one of the first primary optical path and the first backup optical path.

7. The optical repeater in accordance with claim 6, wherein the optical switching mechanism is further configured to automatically detect when the second primary optical path is defective.

8. The optical repeater in accordance with claim 6, wherein the optical switching mechanism is configured to provide the second received optical signals to both of the first primary optical path and the first backup optical path simultaneously.

9. The optical repeater in accordance with claim 6, wherein the optical switching mechanism is configured to provide the second received optical signals to the first primary optical path if the first primary optical path is not defective, and to the first backup optical path if the first primary optical path is defective.

10. The optical repeater in accordance with claim 6, further comprising:
a portion of the first primary optical path that includes a first line amplifier and a first booster amplifier;
a portion of the first backup optical path that includes a second line amplifier and a second booster amplifier;
a portion of the second primary optical path that includes a third line amplifier and a third booster amplifier; and
a portion of the second backup optical path that includes a fourth line amplifier and a fourth booster amplifier.

11. An optical transmission system comprising:
a first terminal;
a second terminal;
a repeater optically disposed between the first and second terminals;
a first optical path optically coupling a first optical node and the repeater, the first optical node either being the first terminal, or being a node optically between the first terminal and the repeater;
a second optical path optically coupling the first optical node and the repeater;
a third optical path optically coupling a second optical node and the repeater, the second optical node either being the second terminal, or being a node optically between the second terminal and the repeater;
a fourth optical path optically coupling the second optical node and the repeater;
wherein the optical transmission system is configured to transmit an optical signal from the first node over at least one of the first optical path and the second optical path; and
wherein the repeater comprises an optical switching module that is configured to receive the optical signal from whichever of the first and second optical paths is operational when one of the first and second optical paths is defective, and channel the optical signal to at least one of the third optical path or the fourth optical path.

12. The optical transmission system in accordance with claim 11, wherein the first node is, comprises, or is comprised by the first terminal.

13. The optical transmission system in accordance with claim 12, wherein the second node is, comprises, or is comprised by the second terminal.

14. The optical transmission system in accordance with claim 11, wherein the second node is, comprises, or is comprised by the second terminal.

15. The optical transmission system in accordance with claim 11, wherein at least one of the first, second, third, or fourth optical paths comprises at least one other repeater.

16. The optical transmission system in accordance with claim 11, wherein the repeater is a first repeater, and wherein the first node is a second repeater.

17. The optical transmission system in accordance with claim 16, wherein the second node is a third repeater.

18. The optical transmission system in accordance with claim 11, wherein the repeater is a first repeater, and wherein the second node is a second repeater.

19. The optical transmission system in accordance with claim 11, wherein the average optical length of the first, second, third and fourth optical paths is at least 50 kilometers.

20. The optical transmission system in accordance with claim 11, wherein the average optical length of the first, second, third and fourth optical paths is at least 200 kilometers.
